(19) United States
(12) Patent Application Publication
(10) Pub. No.: US 2009/0150306 A1
(43) Pub. Date: Jun. 11, 2009

(54) Method of providing services using controlled access to vehicles of customers

(76) Inventor: David Matthew Campbell, Highland, MD (US)

Correspondence Address: MARTIN & FERRARO, LLP, 1557 LAKE O'PINES STREET, NE, HARTVILLE, OH, 44632, US

(21) Appl. No.: 12/316,151

(22) Filed: Dec. 10, 2008

Related U.S. Application Data
(60) Provisional application No. 61/005,971, filed on Dec. 10, 2007.

(51) Int. Cl. G06Q 90/00; B60R 25/00

(52) U.S. Cl. 705/500; 340/5.73

(57) ABSTRACT

A method of granting a service provider access to a vehicle of a customer to facilitate provision of services therefor is disclosed. The method includes the acts of scheduling a service appointment with the service provider for servicing at least one of the vehicle and articles placed within the interior or trunk of the vehicle, and, if the service appointment is scheduled for the articles, then locking the interior or trunk of the vehicle with the articles placed therein. The method further includes the acts of attaching a security storage box to the vehicle or in proximity to the vehicle, and locking a means for accessing the interior or trunk of the vehicle in the security storage box, granting access to the service provider to the means for accessing locked in the security storage box, and permitting access to the interior or trunk of the vehicle using the means for accessing to afford service to the vehicle or the articles.

### RELATED APPLICATIONS

This application claims the benefit of U.S. Provisional Application No. 61/005,971, which is incorporated herein by reference.

### BACKGROUND OF THE INVENTION

1. Field of the Invention

The present invention is generally related to a method for providing services to customers using controlled access to the customers' vehicles to facilitate the provision thereof. More particularly, the present invention is related to a method for providing scheduled services to customers relying on granting of controlled access to the customers' vehicles to facilitate exchanges between the customers and service providers. More specifically, the present invention is related to a method of scheduling a date and location for the provision of services, and performing the scheduled services to customers by relying on the customers' vehicles and controlled access granted thereto as a platform to facilitate exchanges between the customers and service providers.

2. Description of the Prior Art

Typically, customers requiring services depend on service providers to have fixed locations or service vehicles to facilitate the provision of such services. As such, the customers must visit the fixed locations and/or the service vehicles must visit the customers to initiate and complete the service. Either way, the customers (or their agents) oftentimes must at some time meet with the service providers to facilitate the provision of such services. Given the conflicting schedules thereof, arranging such a meeting may never be convenient for the customers and service providers.

For example, difficulties may arise in arranging service for vehicles. Rather than servicing vehicles themselves, vehicle owners oftentimes rely on service garages to service their vehicles. In doing so, vehicle owners either remain onsite or leave their vehicles at the service garages for servicing. As such, the vehicle owners must either wait until servicing of their vehicles is complete, or, if their vehicles are left at the service garages, arrange for transportation from and back to the service garages. Either way, the vehicle owners are exposed to the inconvenience of waiting or arranging transportation. In certain circumstances, when the wait for service is excessive, or the service garages are located far from the vehicle owners' place of business or home, the vehicle owners can be extremely inconvenienced.

Furthermore, even if the service garages employed service vehicles, the vehicle owners must still meet the employees operating the service vehicles at their place of business or home to facilitate performance of the service. Unless the vehicles are left unlocked or the service garages are previously provided with access, the employees operating the service vehicles would not have access to the vehicles without meeting the vehicle owners.

Accordingly, for the convenience of customers, there is a need for a method for providing services to customers using controlled access to the customers' vehicles to facilitate the provision thereof. Such a method can employ the convenience of email and/or the Internet for account setup and scheduling, and rely on granting of controlled access to the customers' vehicles to facilitate exchanges between the customers and service providers, and thus enable the service providers to provide the scheduled services.

### SUMMARY OF THE INVENTION

The present invention in one preferred embodiment contemplates method of granting a service provider access to a vehicle of a customer to facilitate provision of services therefor including the acts of scheduling a service appointment with the service provider for servicing at least one of the vehicle and articles placed within the interior or trunk of the vehicle, if the service appointment is scheduled for the articles, then locking the interior or trunk of the vehicle with the articles placed therein, attaching a security storage box to the vehicle or in proximity to the vehicle, and locking a means for accessing the interior or trunk of the vehicle in the security storage box, granting access to the service provider to the means for accessing locked in the security storage box, and permitting access the interior or trunk of the vehicle using the means for accessing to afford service to the vehicle or the articles.

The present invention in a further preferred embodiment contemplates a method of accessing a vehicle of a customer by a service provider to facilitate provision of services therefor including the acts of confirming an appointment with the customer for servicing at least one of the vehicle and articles placed within the interior or trunk of the vehicle, locating the vehicle on a date and at a location selected by the customer, unlocking a security storage box attached to the vehicle or in proximity to the vehicle to obtain a means for accessing the interior or trunk of the vehicle, accessing the interior or trunk of the vehicle using the means for accessing, if the service appointment is for the vehicle, servicing the vehicle, if the service appointment is for the articles, removing the articles, servicing the articles, and returning the articles to the interior or trunk of the vehicle, and, after the service is complete, locking the vehicle.

The present invention in another preferred embodiment contemplates a method of accessing a vehicle of a customer by a service provider to facilitate provision of services therefor including establishing an account with the service provider, scheduling a specified date and a specified location for a service appointment, scheduling services to be performed by the service provider during the service appointment, attaching a security storage box to the vehicle or in proximity to the vehicle, and locking a means for accessing the interior or trunk of the vehicle in the security storage box, granting access to the service provider to the means for accessing locked in the security storage box, locating the vehicle on the specified date in the specified location, unlocking the security storage box to obtain the means for accessing, accessing the interior or trunk of the vehicle using the means for accessing, and performing the service, and after the service is complete, locking the vehicle.

It is understood that both the foregoing general description and the following detailed description are exemplary and exemplary only, and are not restrictive of the invention as claimed.

### BRIEF DESCRIPTION OF THE DRAWINGS

The accompanying drawings, which are incorporated in and constitute a part of the specification, illustrate preferred embodiments of the invention. Together with the description, they serve to explain the objects, advantages and principles of the invention. In the drawings:

FIG. 1 is a flow chart depicting one embodiment of the method according to the present invention;

FIG. 2 depicts a security storage box attached to a window of a vehicle;

FIG. 2A depicts a perspective view of the security storage box; and

FIG. 3 depicts a mobile service station used as part of the present invention for servicing a vehicle.

### DETAILED DESCRIPTION OF THE PREFERRED EMBODIMENT

The following description is intended to be representative only and not limiting, and many variations can be anticipated according to these teachings. Reference will now be made in detail to the preferred embodiments of this invention, examples of which are illustrated in the accompanying drawings.

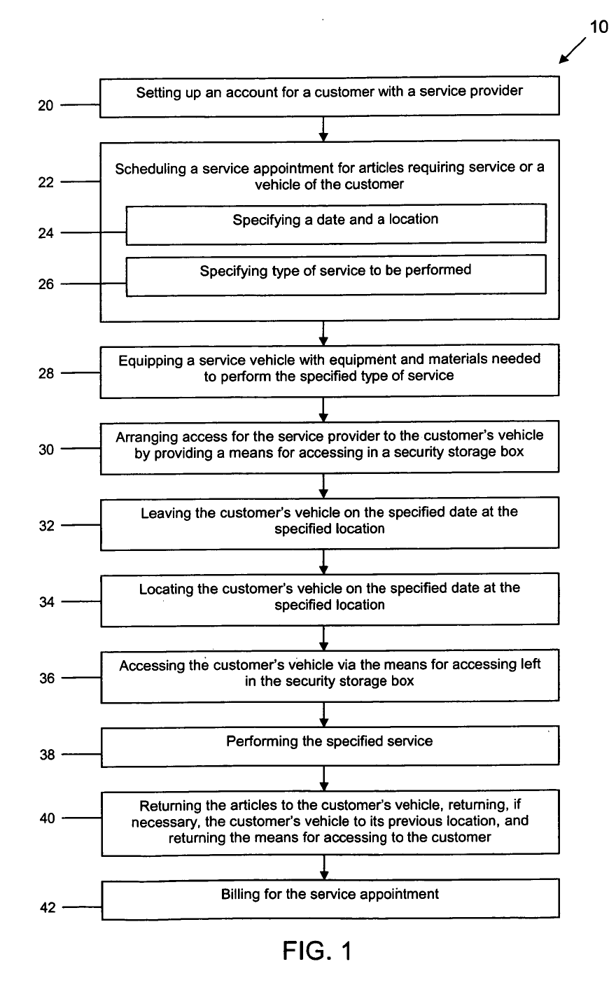

FIG. 1 shows a method according to one embodiment of the present invention which is generally indicated by the numeral 10. Method 10 includes steps numbered 20-42. Using method 10, a service appointment for a vehicle can be scheduled by customers with service providers. In doing so, the customers can schedule a date and a location for the service appointment, and request the type of services to be performed. The method 10, as discussed below, relies on controlled access to vehicles 12 of the customers to facilitate exchanges between the customers and service providers, and thus enable the service providers to provide the scheduled services. In doing so, customers' vehicles 12 serve as a platform facilitating exchanges between the customers and service providers.

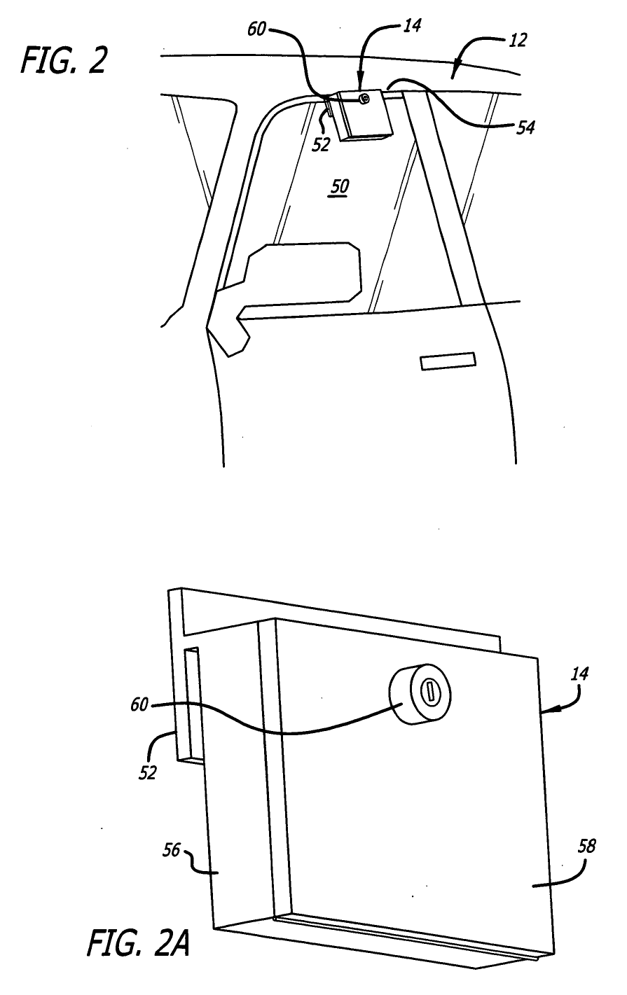

As discussed below, a security storage box (or lock box) 14 (shown in FIGS. 2 and 2A), and a key, a keyless entry device, or a note with a security code provided thereon are used in granting controlled access to a vehicle 12 of the customer. Using security storage box 14, the customer's vehicle 12 can be locked, but access to the interiors or trucks thereof can be still granted to the service providers.

Using method 10, the customer can schedule services for articles requiring pick up and drop off from their vehicles, and/or schedule services for the vehicles themselves. For example, on a specified date while the customers' vehicles can be parked at, for example, a specified location such as at or adjacent the customer's place of business or home. On the specified date, the service providers drive to the specified location to pick up or drop off articles from the interiors or trunks of the customers' vehicles or perform the scheduled services thereon.

Services provided by the service providers can include, but are not limited to, laundry service and dry-cleaning services. Other services where customers can leave articles in the vehicles 12 for pick up are also contemplated using method 10. With access thereto, the service providers can pick up the clothing (or other articles) from the customers' vehicles 12, perform the laundry and dry-cleaning (or other) services, and drop off the clothing (or other articles) once those services are completed. Furthermore, the services provided on the vehicles themselves can include, but are not limited to, changing fluids of the vehicle, replacing parts on the vehicle, checking tire pressure and battery charge, and detailing the vehicle.

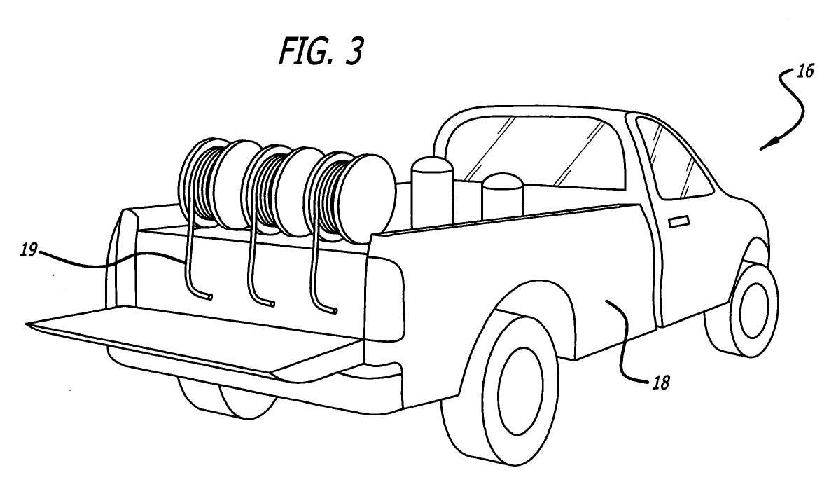

The service providers can employ service vehicles 16 adapted to facilitate the services provided. For example, if the service providers are providing service on the customers' vehicles, service vehicles such as a mobile service station 18 (FIG. 3) can be used.

As shown in FIG. 3, mobile service station 18 can be a pickup truck, and equipment and materials generally indicated by the numeral 19 mounted thereon for performing the scheduled services. Depending on the type of scheduled services to be provided, mobile service station 18 can be equipped with different equipment and materials for a particular service appointment. Furthermore, although, as shown in FIG. 3, mobile service station 18 is a pickup truck, mobile service station 18 is not limited thereto. For example, mobile service vehicle 18 can also be a trailer with equipment and materials mounted thereon.

For example, to change the fluids of the vehicle, the mobile service station 18 can be equipped with a jack stand for access to the undercarriage of the vehicle and/or vacuum system (e.g., Sage OIL VAC® vacuum system) to drain and withdraw, respectively, fluids from the vehicle. The vacuum system can be used to reduce the possibility of spillage of fluids. Furthermore, the mobile service station 18 can be equipped with storage tanks, drums, and/or cans containing various fluids, as well as fluid dispensers for replenishing the fluids from the vehicle. The fluids can include any fluids useful in the maintenance, repair, and/or care of a vehicle in particular including, but not limited to various grades of motor oil, antifreeze, transmission/transaxle fluid, differential fluid, power steering fluid, gasoline, water, and/or windshield-wiper fluid. Therefore, if the scheduled services include changing and/or filling any of the above-mentioned fluids, mobile service station 18 can be equipped to facilitate such services. For example, the scheduled services can include changing the oil of the vehicle and filling the vehicle with gasoline.

Additionally, mobile service station 18 can include storage for replacement parts for the vehicle. Such replacement parts can include, for example, air filters, oil filters, windshield-wiper blades, and bulbs for exterior lights. Therefore, depending on the scheduled services, mobile service station 18, in addition to the above-discussed equipment and materials, can include replacement parts necessary to complete the services. Furthermore, if the scheduled services include checking and adjusting the vehicle's tire pressure and/or battery charge, mobile service station 18 can include an air compressor and a battery charger, respectively. Moreover, if the scheduled services include detailing the vehicle, the mobile station can include car-washing tools and/or a vacuum cleaner. Accordingly, equipping mobile service station 18 with the above-discussed equipment and materials affords the service provider flexibility to provide the scheduled services.

Using method 10, a customer at step 20, before setting up a service appointment for articles requiring service or the customer's vehicle 12, sets up an account with the service provider. In doing so, the customer can set up the account via telephone or the Internet using a website associated with the service provider. For example when setting up an account, the customer submits contact, billing, and vehicle information to the website of the service provider. The contact and billing information, for example, can include name, address, phone number, and payment details. Furthermore, to facilitate use of the customer's vehicle 12 as a platform facilitating exchanges between the customer and service provider, information regarding vehicle 12 is provided to the service provider. Such vehicle information can include the vehicle's license number, year, make, model, and possibly a picture of the vehicle, and, if the customer's vehicle is to be serviced, the vehicle's mileage and service history.

Once the account is set up, at step 22 the customer can schedule a service appointment also via telephone or the Internet. When using the Internet to schedule the service appointment, information can be exchanged between the customer and service provider using the website or by email-based communication. For example, the website of the service provider can be adapted with input and output fields to afford scheduling of a service appointment by the customer, or the customer and service provider can communicate regarding scheduling via email.

When scheduling the service appointment, the customer at step 24 can ascertain available dates and locations provided (via telephone and/or the Internet) by the service provider, and can schedule a date and a location for the service appointment accordingly. Furthermore, at step 26 the customer can request and/or select (via telephone and/or the Internet) the type of services to be performed. The availability of service appointments may depend on whether the service provider will be servicing a particular locale. Alternatively, the service provider can email the customer with dates that a particular locale will be served, and ask whether a service appointment is needed. By return email, the customer can schedule a date and a location for the services accordingly, and request the types of services to be performed on the vehicle.

Prior to the service appointment for the vehicle, the service provider can provide mobile service station 18 at step 28 with equipment and materials 19 necessary to facilitate transport of the articles and/or provide the scheduled services.

Also prior to the service appointment, the customer at step 30 can arrange for the service provider to have access to the vehicle. As discussed above, the customer can utilize security storage box 14 such as that shown in FIG. 3 to grant access to the customer's vehicle even when locked.

To grant access to the service provider, security storage box 14 can be attached, for example, to a window 50 of the customer's vehicle 12, or in close proximity thereto. To secure security storage box 14 to the customer's vehicle 12, a portion thereof can be trapped between the window and door jam/frame of the vehicle 12. Furthermore, besides being attached to the customer's vehicle, security storage box 14 could be fixedly attached to a structure adjacent the location where the vehicle is ultimately parked.

Security storage box 14 includes a lip 52 to facilitate attachment of the customer's vehicle 12. During attachment, window 50 is inserted between lip 52 and the remainder of security storage box 14. Thereafter, the closing of window 50 secures security storage box 14 to the customer's vehicle 12 by trapping security storage box 14. As shown in FIG. 2, security storage box 14 is trapped between window 50 and a door jam 54 of the customer's vehicle 12. For other vehicles (not shown), storage box 14 could be trapped between the window and a door frame (not shown) thereof.

Security storage box 14 can be purchased by the customer, or loaned to or rented by the service provider to the customer. Security storage box 14 (besides lip 52) also includes body 56, a lid 58, and a lock 60. Lid 58 is hingedly connected to body 56, and a compartment (not shown) formed in body 56 can be covered by lid 58. Lock 60 (such as a combination or keyed lock) is used to secure lid 58 to body 56, and restrict access to the compartment. As such, the key, the keyless entry device, and/or the note with the security code provided thereon for the customer's vehicle 12 can be placed in the compartment to be locked inside security storage box 14.

An exemplary security storage box 14 is sold by HPC, Inc. under the brand-name Auto Key Keeper™. Whether purchased, loaned or rented, access to the security storage box 14 must be arranged. If purchased, the combination or a copy of an individualized key can be provided to the service provider by the customer to gain access to the interior of security storage box 14. If loaned or rented, a combination or copy of an individualized key can be provided to the customer, and the service provider can rely on the combination and the individualized key, or a master key applicable to some or all of the boxes loaned or rented thereby to gain access to security storage box 14.

When loaned to the customer, the service provider can retrieve security storage box 14 from the customer at the time the scheduled services have been performed. As such, the services can be performed on a single occasion without the need for the service provider to retrieve security storage box 14 at a later time.

Use of security storage box 14 grants access to the key, the keyless entry device, and/or or the note with the security code provided thereon for customer's vehicle 12 by the service provider, and hence, grants access to the customer's locked vehicle. With such access, the service provider can pick up and drop off articles requiring service, and perform services on the customer's vehicle 12. Furthermore, with the access to the customer's vehicle 12 afforded by security storage box 14, the services can be provided without need of a meeting between the customer and service provider.

Once the customer has scheduled a date and location for the service appointment and provided access for the service provider to the vehicle, customer at step 32 leaves the vehicle on the specified date in the specified location. If necessary, the precise location of the vehicle can be provided by the customer (via telephone and/or the Internet) on the date of service appointment to the service provider. For example, if the customer, while at work, parks the vehicle in a parking garage or lot, the precise location (e.g., parking space, row, and/or deck number within the parking garage or lot) of the vehicle can be provided to the service provider.

Thereafter, the service provider at step 34 locates the vehicle. Security storage box 14 can itself service as an identifier of which vehicle is the customer's vehicle 12. For example, security storage box 14 can be colored and/or include markings identifying the customer. Furthermore, security storage box 14 can be equipped with a GPS (global positioning system) locator and/or a RFID (radio frequency identification) locator. Using these locators, the service provider can pinpoint the location of the customer's vehicle 12.

However, to locate the vehicle, the service provider must also have access to the location where the vehicle is located. If the vehicle is parked at the home of the customer, then the customer can provide access to the vehicle. However, if the vehicle is parked in a parking garage or lot, the service provider must have access to the parking garage or lot. Accordingly, the service provider may arrange by agreement with the owner or operator of the parking garage or lot for access thereto. Such an agreement can be mutually beneficial to the service provider and the owner or operator. For example, in exchange for access to the parking garage or lot, the service provider can provide exclusivity by agreeing to only service that particular parking garage or lot. The owner or operator of the parking garage or lot can then market their parking services to patrons thereof as having the exclusive benefits afforded by the service provider. Furthermore, such an agreement could afford the service provider permission to market services to the patrons of the parking garage or lot.

At step 36, the service provider accesses security storage box 14 to obtain the key, the keyless entry device, and/or the note with the security code provided thereon to gain access to the customer's locked vehicle.

Thereafter, at step 38, the specified services are performed by the service provider for articles requiring service or on the customers' vehicles. To facilitate service of the articles, the service provider (with access to the customer's vehicle) can pick up and remove the articles from the customer's vehicle 12 and then service the articles. If necessary, the service provider can remove the articles to a remote location to perform the services.

Furthermore, when servicing the customer's vehicle 12, the key, the keyless entry device, and/or the security code provided by the customer will afford the service provider access to the vehicle, and, if necessary, allow the vehicle to be temporarily moved. In doing so, spill/safety mats can be placed under the vehicle. The spill/safety mats cover and protect the surroundings, for example, in the parking garage or lot where the vehicle is parked. Furthermore, if the vehicle is moved from a parking space in a parking garage or lot, a space holder such as a sign, parking cone, or other physical barrier can be positioned in that parking space. If using a sign, the sign can, for example, indicate that any vehicle parked in that parking space will be towed.

After the scheduled services have been performed, at step 40 the service provider can drop off and return the articles to the customer's vehicle 12, and lock vehicle 12 with the articles placed therein. If necessary, the vehicle can be returned to its previous location.

At step 40, the key, the keyless entry device, and the note with the security code provided thereon can be returned to the customer using security storage box 14, and an indicator can be left on the vehicle noting that scheduled services have been completed. Furthermore, if security storage box 14 has been loaned to the customer, the service provider, rather than returning them in security storage box 14, can leave the key, the keyless entry device, or the note with the security code provided thereon in the customer's locked vehicle 12. In doing, the service provider can retrieve security storage box 14 from the customer at the time the scheduled services have been performed. By retrieving security storage box 14 at the time the scheduled services have been performed, the service provide can remove the necessity for retrieving security storage box 14 from the customer at a later time.

Thereafter, at step 42, the customer can be billed, and a detailed receipt and any additional information regarding the scheduled services can be left in the compartment of security storage box 14 or in the interior or trunk of the customer's vehicle 12. Furthermore, the detailed receipt and the additional information can be communicated to the customer via the Internet. In doing so, the detailed receipt and the additional information can be reviewed by the customer, for example, through the website of the service provider or emailed to the customer.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

I claim:

1. A method of granting a service provider access to a vehicle of a customer to facilitate provision of services therefor, the method comprising:
scheduling a service appointment with the service provider for servicing at least one of the vehicle and articles placed within the interior or trunk of the vehicle;
if the service appointment is scheduled for the articles, then locking the interior or trunk of the vehicle with the articles placed therein;
attaching a security storage box to the vehicle or in proximity to the vehicle, and locking a means for accessing the interior or trunk of the vehicle in the security storage box;
granting access to the service provider to the means for accessing locked in the security storage box; and
permitting access to the interior or trunk of the vehicle using the means for accessing to afford service to the vehicle or the articles.

2. The method of claim 1, wherein the means for accessing includes a key, keyless entry device, and a security code for unlocking the interior or trunk of the vehicle.

3. The method of claim 1, wherein access is granted to the security storage box via at least one of a key and combination to a lock provided thereon.

4. The method of claim 1, further comprising establishing an account with the service provider.

5. The method of claim 4, wherein the act of establishing an account includes providing at least one of contact, billing, and vehicle information to the service provider.

6. The method of claim 1, wherein the availability of a service appointment is correlated to whether the service provider is servicing a particular locale.

7. The method of claim 1, wherein the act of scheduling includes selecting a date and a location for the service appointment.

8. The method of claim 7, further comprising parking the vehicle on the selected date at the selected location.

9. A method of accessing a vehicle of a customer by a service provider to facilitate provision of services therefor, the method comprising:
confirming an appointment with the customer for servicing at least one of the vehicle and articles placed within the interior or trunk of the vehicle;
locating the vehicle on a date and at a location selected by the customer;
unlocking a security storage box attached to the vehicle or in proximity to the vehicle to obtain a means for accessing the interior or trunk of the vehicle;
accessing the interior or trunk of the vehicle using the means for accessing;
if the service appointment is for the vehicle, servicing the vehicle;
if the service appointment is for the articles, removing the articles, servicing the articles, and returning the articles to the interior or trunk of the vehicle; and
after the service is complete, locking the vehicle.

10. The method of claim 9, further comprising locking the security storage box with the means for accessing placed therein after the service is complete.

11. The method of claim 9, wherein the means for accessing includes a key, keyless entry device, and a security code for unlocking the interior or trunk of the vehicle.

12. The method of claim 9, wherein unlocking the security storage box is afforded via at least one of a key and combination to a lock provided thereon.

13. The method of claim 9, further comprising permitting the customer to establish an account with the service provider.

14. The method of claim 13, wherein the act of permitting the customer to establish an account includes requesting at least one of contact, billing, and vehicle information from the customer.

15. The method of claim 9, wherein the act of removing the articles includes removing the articles from the interior or trunk of the vehicle to a remote location where the service can be performed thereon.

16. The method of claim 9, further comprising equipping a mobile service vehicle with equipment and articles to perform the service.

17. A method of accessing a vehicle of a customer by a service provider to facilitate provision of services therefor, the method comprising:
establishing an account with the service provider;
scheduling a specified date and a specified location for a service appointment;
scheduling services to be performed by the service provider during the service appointment;
attaching a security storage box to the vehicle or in proximity to the vehicle, and locking a means for accessing the interior or trunk of the vehicle in the security storage box;
granting access to the service provider to the means for accessing locked in the security storage box;
locating the vehicle on the specified date in the specified location;
unlocking the security storage box to obtain the means for accessing;
accessing the interior or trunk of the vehicle using the means for accessing; and
performing the service, and after the service is complete, locking the vehicle, and locking the security storage box with the means for accessing placed therein.

18. The method of claim 17, further comprising locking the security storage box with the means for accessing placed therein after the service is complete.

19. The method of claim 17, wherein the means for accessing includes a key, keyless entry device, and a security code for unlocking the interior or trunk of the vehicle.

20. The method of claim 17, wherein unlocking the security storage box is afforded via at least one of a key and combination to a lock provided thereon.

21. The method of claim 17, wherein the service appointment is for servicing at least one of the vehicle and articles placed within the interior or trunk of the vehicle.

22. The method of claim 21, further comprising, if the service appointment is for the articles, removing the articles, and returning the articles to the interior or trunk of the vehicle after the service is complete.
